(19) United States
(12) Patent Application Publication
(10) Pub. No.: US 2007/0232757 A1
(43) Pub. Date: Oct. 4, 2007

(54) Mar resistant, glossy thermoplastic polyolefin blends and articles

(76) Inventors: Kevin Cai, Arlington, TX (US); Cynthia Lim, Arlington, TX (US)

Correspondence Address: WINSTON & STRAWN LLP;PATENT DEPARTMENT, 1700 K STREET, N.W., WASHINGTON, DC, 20006, US

(21) Appl. No.: 11/395,147

(22) Filed: Apr. 3, 2006

(51) Int. Cl. C08L 23/04

(52) U.S. Cl. 525/240

(57) ABSTRACT

A scratch resistant and mar abrasion resistant thermoplastic polyolefin blend that includes at least one semi-crystalline polypropylene resin component, at least one styrene-based elastomer component, at least one vinyl cyanide component, and at least one processability modifier component. The processability modifier component contains at least one pair of oxygen atoms bonded by a single covalent bond, and is present in an amount sufficient to provide an amount active oxygen of about 4 to 500 parts per million (ppm) of the thermoplastic polyolefin blend.

### TECHNICAL FIELD

This invention relates generally to thermoplastic polyolefin blends including a semi-crystalline polypropylene resin component, a vinyl cyanide component a styrene-based elastomer component; and a processability modifier component containing at least one pair of oxygen atoms bonded by a single covalent bond, to provide superior physical properties, such as a combination of stiffness, scratch resistance, and mar abrasion resistance. The invention also relates to compositions containing such blends, molded or extruded articles using such blends, as well as to methods for producing compositions and articles using the same.

### BACKGROUND OF THE INVENTION

A glossy surface appearance is a desirable attribute for molded or extruded plastic parts (e.g., automotive body panels and trim parts, household appliances, etc.). The gloss of a surface is determined by the amount of light that is scattered when light hits the surface of the object. Because the scattering is a function of the roughness of the surface, an aesthetically pleasing surface should not only be glossy but should also be resistant to scratches and mar abrasions. In the past, parts requiring a glossy, durable surface have been either painted or laminated with a film, thus requiring an additional manufacturing step. Traditional painting techniques also involve potentially dangerous levels of airborne pollutants.

A thermoplastic resin composition that is useful for interior and exterior trim parts of automobiles due to its improved paint adhesiveness, for example, is disclosed in U.S. Pat. No. 4,739,011. The composition includes 40 to 75 weight percent of propylene resin, 20 to 40 weight percent of an ethylene-alpha-olefin copolymer, 5 to 30 weight percent of a graft copolymer containing an aromatic vinyl compound and a polar vinyl compound copolymerized in the presence of an ethylene-alpha-olefin, 0.1 to 5 parts by weight of an unsaturated dicarboxylic acid or anhydride, and 0.01 to 0.3 parts by weight of an organic radical generating agent.

A thermoplastic blend exhibiting a sufficiently high surface gloss without requiring additional treatment (i.e., painting or film laminating) is desirable. A method for eliminating the need to paint the exterior parts of vehicles through the addition of special effects pigments, for example, is disclosed in U.S. Pat. No. 6,017,989. A process for increasing the scratch resistance of polyolefin material by reacting a propylene polymer with a poly(sulfonyl)azide is disclosed in U.S. Pat. No. 6,734,253. Scratch damage is a type of friction-induced damage in which a sharp object causes cutting type behavior at the material surface, leading to actual removal or displacement of material at the point of damage. Scratch resistant materials may not, however, be resistant to mar abrasion.

The term “mar abrasion” is used to describe surface defects that are large enough to degrade the appearance of a polymer surface but the damage is restricted to within a few micrometers of the material's surface. One major source of mar is car washing where dust embedded in the car-washing brush causes numerous micro-scale scratches in the surface. The overall effect is sometimes referred to as swirl marks.

There remains a need to obtain thermoplastic polyolefin blends having the desired balance of good mar abrasion resistance, scratch resistance, and glossiness, but without the need for further treatment (i.e., painting or laminating), and that has the physical property requirements of rigidity, strength, and processability.

### SUMMARY OF THE INVENTION

The invention encompasses a thermoplastic polyolefin blend including a semi-crystalline polypropylene resin component in an amount sufficient to impart rigidity to the blend, a vinyl cyanide component in an amount sufficient to impart mar abrasion resistance to the blend, a styrene-based elastomer component in an amount sufficient to compatibilize the blend, and a processability modifier component containing at least one pair of oxygen atoms bonded by a single covalent bond in an amount sufficient to enhance processability of the blend.

In one embodiment, the processability modifier is present in an amount sufficient to impart an active oxygen content of about 4 ppm to 500 ppm of the thermoplastic blend. In a preferred embodiment, the amount of active oxygen present is from about 10 ppm to 250 ppm of the thermoplastic blend.

In another embodiment, the semi-crystalline polypropylene resin component is present in an amount from about 1 weight percent to 99 weight percent, the vinyl cyanide component is present in an amount from about 1 weight percent to 75 weight percent, and the styrene-based elastomer component is present in an amount from about 0.01 weight percent to 75 weight percent, each based on the total weight of the polymers in the blend. In a preferred embodiment, the semi-crystalline polypropylene resin component is present in an amount from about 20 weight percent to 95 weight percent, the vinyl cyanide component is present in an amount from about 5 weight percent to 60 weight percent, and the styrene-based elastomer component is present in an amount from about 0.1 weight percent to 70 weight percent, each based on the total weight of the polymers in the blend.

In another embodiment, the processability modifier component includes one or more organic peroxide components, organic hydroperoxide components, organic azo components, inorganic peroxides, percarbonate and/or perborate components, or any combination thereof. In a preferred embodiment, the organic peroxide is present and includes one or more peroxyketals; hydroperoxides; dialkyl peroxides; diacyl peroxides; peroxyesters; or any combination thereof.

In yet another embodiment, the vinyl cyanide component is in the form of a rubber-reinforced copolymer resin including at least one polar vinyl monomer present in an amount from about 5 weight percent to 75 weight percent, at least one aromatic vinyl monomer in an amount from about 10 weight percent to 80 weight percent, and at least one rubber moiety present in an amount from about 15 weight percent to 85 weight percent, each based on the total weight of the vinyl cyanide component. In a preferred embodiment, the at least one polar vinyl monomer is present in an amount from about 10 to 65 weight percent, the at least one aromatic vinyl monomer is present in an amount from about 10 to 65 weight percent, and the at least one rubber moiety is present in an amount from about 25 to 60 weight percent, each based on the total weight of the vinyl cyanide component. In a more preferred embodiment, the at least one polar vinyl monomer includes one or more of acrylonitrile, acrylic acid esters, methacrylic acid esters, or a combination thereof; the at least one aromatic vinyl monomer includes styrene, p-methylstyrene, o-methylstyrene, ethylstyrene, 2,4-dimethylstyrene, and vinylnaphthalene, or a combination thereof; and the at least one rubber moiety includes ethylene/propylene rubber, ethylene/propylene/diene rubber, or a combination thereof.

In another embodiment, the vinyl cyanide component includes one or more of ethylene/propylene rubber-reinforced styrene/acrylonitrile copolymers, ethylene/propylene/diene rubber-reinforced styrene/acrylonitrile copolymers, ethylene/propylene rubber-reinforced acrylate/styrene/acrylonitrile copolymers, and ethylene/propylene/diene rubber-reinforced acrylate/styrene/acrylonitrile copolymers. In yet another embodiment, the styrene-based elastomer component is in the form of a block or random styrene copolymer that includes a styrenic component and a hydrogenated olefinic component. In a preferred embodiment, the styrene-based elastomer component is selectively hydrogenated so that at least about 80% of the double bonds in the hydrogenated olefinic component are hydrogenated and less than about 65% of the double bonds of the styrenic component are hydrogenated. In another preferred embodiment, the styrene-based elastomer component includes styrene-ethylene-butylene-styrene, styrene-ethylene-propylene-styrene, styrene-ethylene-propylene-styrene-styrene-ethylelene-propylene-styrene, or styrene-ethylene-ethylene-propylene-styrene, or a combination thereof.

In another embodiment, the semi-crystalline polypropylene resin component includes one or more homopolymers of propylene, one or more copolymers of at least 50 weight percent propylene and at least one other C₂ to C₂₀ alpha-olefin, or mixtures thereof, and the resin component is present in an amount of between about 30 weight percent to 90 weight percent based on the total weight of the polymers in the blend. In any of the above embodiments, the invention may further include one or more thermal stabilizers, mineral fillers, ultraviolet stabilizers, antioxidants, flame retardants, dispersants, antistatic agents, internal lubricants, processing aids, nucleating agents, plasticizers, colorants, mold release agents, pigments, or a combination thereof. In a preferred embodiment, an internal lubricant is present and includes one or more fatty acids, fatty acid esters, fatty acid amides, polyolefin waxes, silicone oil, or a combination thereof.

The invention also encompasses molded articles including or formed from the blends described above or otherwise herein. In similar fashion, the invention further encompasses extruded or co-extruded articles including any of these blends above or otherwise described herein. For co-extruded articles, in a preferred embodiment, the inventive thermoplastic polyolefin blend is extruded over another layer formed from a different thermoplastic polyolefin material.

The invention further encompasses methods of preparing thermoplastic polyolefin blends of the invention by providing a semi-crystalline polypropylene resin component in an amount sufficient to impart rigidity to the blend, a vinyl cyanide component in an amount sufficient to impart mar abrasion resistance to the blend, a styrene-based elastomer component in an amount sufficient to compatibilize the blend, and a processability modifier component containing at least one pair of oxygen atoms bonded by a single covalent bond, to form a polymerizable blend, and copolymerizing the polymerizable blend sufficiently to provide the thermoplastic polyolefin blend.

### DETAILED DESCRIPTION OF THE PREFERRED EMBODIMENTS

In accordance with the present invention, it has now been found that the surface appearance of an article formed from a thermoplastic polyolefin blend, e.g., by extruding or molding, can be enhanced by including in the blend a sufficient amount of at least one semi-crystalline polypropylene resin component to increase the rigidity of the blend, a sufficient amount of at least one vinyl cyanide component to increase the mar abrasion resistance of the blend, and a sufficient amount of at least one styrene-based elastomer component to compatibilize the blend, and at least one processability modifier component. The thermoplastic polyolefin blend containing the processability modifier component and other components noted above may be, e.g., injection molded into a molded part or may be extruded or co-extruded into an extruded sheet, wherein the surface of the part thus obtained is at least substantially free, and preferably entirely free, of visible surface defects such as cloudiness or haze.

The semi-crystalline polypropylene resin component is present in an amount of about I weight percent to 99 weight percent, preferably from about 20 weight percent to 95 weight percent, and more preferably from about 40 weight percent to 90 weight percent, based on the total weight of the polymers present in the blend. This semi-crystalline polypropylene resin component can include one or more semi-crystalline polypropylene resins and may be of any type available to those of ordinary skill in the art. Typically, the semi-crystalline polypropylene resin component is chosen from one or more homopolymers of propylene, one or more copolymers of at least 50 weight percent propylene and at least one other C₂ to C₂₀ alpha-olefin, or any mixture thereof. Copolymers of propylene, if used, may preferably include a random copolymer or an impact block copolymer (i.e., a block copolymer composed of propylene polymer units and ethylene/propylene copolymer units). Preferred alpha-olefins for such copolymers include ethylene, 1-butene, 1-pentene, 1-hexene, methyl-1-butenes, methyl-1-pentenes, 1-octene, 1-decene, or a combination thereof.

“Semi-crystalline,” as used herein, typically means that the crystallinity is at least about 40%, preferably at least about 55%, and more preferably at least about 80%. Moreover, the semi-crystalline polypropylene resin has a typical melt flow rate (as determined by ASTM D-1238-01 at a temperature of 230° C. and at a load of 2.16 kg) from about 0.001 dg/min to about 500 dg/min, preferably from about 0.01 dg/min to about 250 dg/min, and more preferably from about 0.1 dg/min to 150 dg/min. The semi-crystalline polypropylene component is further characterized by a density typically ranging from about 0.897 g/cm³ to about 0.925 g/cm³ and by a weight average molecular weight (Mw) from about 85,000 to 900,000, preferably from about 90,000 to less than 800,000, and more preferably from about 95,000 to 760,000. In various embodiments, the density ranges from 0.897 g/cm³ to about 0.91 g/cm³ or from about 0.9 g/cm³ to 0.925 g/cm³. Each semi-crystalline polypropylene resin may be grafted or ungrafted. In one embodiment, each semi-crystalline polypropylene resin in the component is essentially free of grafted functional groups (e.g., vinyl groups, carboxylic acids, or anhydrides). In another embodiment, the semi-crystalline polypropylene resin component is completely free of grafted functional groups.

Exemplary semi-crystalline polypropylene homopolymers or copolymers for inclusion in the semi-crystalline polypropylene resin component according to the invention include those that are commercially available as, for example, PROFAX from Basell North America, Inc. of Wilmington, Del. and as various types of polypropylene homopolymers and copolymers from ExxonMobil Chemicals Company of Houston, Tex., from Sunoco Chemicals of Pittsburgh, Pa., from Innovene LLC of Chicago, Ill., and from Dow Chemical Company of Midland, Mich.

The vinyl cyanide component is present in an amount of about 1 weight percent to 75 weight percent, preferably from about 5 weight percent to 60 weight percent, and more preferably from about 7 weight percent to 50 weight percent, based on the total weight of the polymers present in the blend. While any suitable vinyl cyanide component available to those of ordinary skill in the art may be included, the vinyl cyanide component preferably is in the form of a rubber-reinforced copolymer resin, e.g., obtained by polymerizing at least one polar vinyl monomer in the presence of at least one aromatic vinyl monomer, and by modifying the copolymer resin with a rubber moiety. The amount of the at least one polar vinyl monomer present in the vinyl cyanide component is from about 5 weight percent to 85 weight percent, preferably from about 10 weight percent to 70 weight percent, based on the total weight of the vinyl cyanide component. Illustrative examples of polar vinyl monomers include acrylonitrile and its derivatives, such as methacrylonitrile; acrylic acid esters, such as methyl acrylate, ethyl acrylate, butyl acrylate, 2-ethylhexyl acrylate, and the like; methacrylic acid esters, such as methyl methacrylate, ethyl methacrylate and the like; or any combination thereof. The amount of the at least one aromatic vinyl monomer present in the vinyl cyanide component is from about 10 weight percent to 85 weight percent, preferably from about 10 weight percent to 65 weight percent, based on the total weight of the vinyl cyanide component. In one more preferred embodiment, the at least one aromatic vinyl monomer is present in an amount of about 15 weight percent to 50 weight percent of the vinyl cyanide component. Illustrative examples of aromatic vinyl monomers include styrene, p-methylstyrene, o-methylstyrene, ethylstyrene, 2,4-dimethylstyrene, vinylnaphthalene, and the like, or any combination thereof.

The amount of the rubber moiety in the vinyl cyanide component may be selected appropriately so as to satisfy the intended purpose of the present invention and is typically present in an amount from about 15 weight percent to 90 weight percent, preferably from about 20 weight percent to 75 weight percent, and more preferably from about 25 weight percent to 60 weight percent, based on the total weight of the vinyl cyanide component. The rubber moiety typically has an isotactic index of less than about 85, preferably from 0 to about 80. Illustrative examples of the rubber moiety include ethylene/propylene rubber, ethylene/propylene/nonconjugated diene rubber, and the like. The rubber moiety may be added during the copolymerization of one or more vinyl cyanide monomers and one or more aromatic vinyl monomers, or may be added subsequently to the polymerization step. It is known that polymeric components having unsaturated bonds in the main chain, as opposed to side chains, are more susceptible to damage from ultraviolet radiation, oxygen, and ozone. In one embodiment, the vinyl cyanide component is, therefore, essentially free of butadiene. In a preferred embodiment, the vinyl cyanide component is completely free of butadiene.

The vinyl cyanide component may be polymerized by any methods available to those of ordinary skill in the art, preferably by an emulsion polymerization process, a bulk polymerization process, a suspension polymerization process, a solution polymerization process, a block-suspension polymerization process, a bulk-solution polymerization process, a continued block polymerization process, or the like. The preferred vinyl cyanide component includes one or more ethylene/propylene rubber-reinforced styrene/acrylonitrile copolymers, ethylene/propylene/nonconjugated diene rubber-reinforced styrene/acrylonitrile copolymers, ethylene/propylene rubber-reinforced acrylate/styrene/acrylonitrile copolymers, and ethylene/propylene/nonconjugated diene rubber-reinforced acrylate/styrene/acrylonitrile copolymers, or any combination thereof.

Shaped articles formed from the thermoplastic polyolefin blend of the present invention typically present a high gloss, or glossy, surface appearance, as opposed to a matte-type finish. Shaping can be preferably accomplished, for example, with molding or extruding. A method for achieving a low gloss surface appearance for a shaped or molded article by grafting an epoxy group (e.g., glycidyl acrylate, glycidyl methacrylate, or allyl glycidyl ether) onto at least one of the rubber-reinforced copolymers present in the thermoplastic blend is disclosed in, for example, U.S. Pat. No. 4,835,215, which is incorporated herein by express reference thereto. In one embodiment, the vinyl cyanide copolymer is essentially free of grafted epoxy groups. In another embodiment, the vinyl cyanide copolymer is completely free of grafted epoxy groups.

The vinyl cyanide component has a typical melt flow rate (as determined by ASTM D-1238-01) at a temperature of 230° C. and at a load of 10 kg) ranging from about 0.001 dg/min to about 150 dg/min, preferably from about 0.01 dg/min to about 124 dg/min, and more preferably from about 0.05 dg/min to about 90 dg/min. The vinyl cyanide component is further characterized by a density typically ranging from about 0.93 g/cm³ to about 1.15 g/cm³, preferably from about 0.96 g/cm³ to about 1.13 g/cm³, and more preferably from about 1.01 g/cm³ to about 1.12 g/cm³.

Exemplary types of vinyl cyanide materials for inclusion in the vinyl cyanide component according to the invention include those that are commercially available as, for example, DIALAC from UMG ABS, Ltd. of Tokyo, Japan, as UNIBRITE from Nippon A&L Inc. of Osaka, Japan, as CENTREX from Lanxess Corporation of Pittsburgh, Pa., and as various types of vinyl cyanide components from Techno Polymers Co., Ltd. of Tokyo, Japan and from Southland Polymers of Santa Fe Springs, Calif.

It is well known that the morphology of a polymer blend plays a crucial role on its final properties. The incompatibility between various types of polymeric components is responsible for the very poor mechanical properties of most polymer blends. One solution to the problem is the addition of a compatibilizer with segments having specific interactions with the main polymeric components to help facilitate compatibilization thereof. The chains of a compatibilizer tend to have a blocky structure, with one constitutive block miscible with one blend component and a second block miscible with the other blend component. Because the key requirement is miscibility, it is generally not necessary for the copolymer to have identical chain segments as those of the main polymeric components.

The styrene-based elastomer component, which serves to facilitate compatibilization between the semi-crystalline polypropylene resin component and the vinyl cyanide component, is preferably defined as including at least one elastomer having at least one styrenic block component in combination with at least one hydrogenated olefinic block component (e.g., hydrogentated butadiene or hydrogenated isoprene). The styrene-based elastomer component is present in an amount of about 0.01 weight percent to 75 weight percent of the total weight of the polymers present in the overall blend, preferably ranging from about 0.1 weight percent to 70 weight percent, and more preferably from about 1 weight percent to 50 weight percent, based on the total weight of the polymers present in the blend.

The structure of the styrene-based elastomer component useful in the current invention can typically be of the linear or radial type, and preferably of the diblock or triblock type (i.e., styrenic block/hydrogenated olefinic component/styrenic block). The styrenic portion of each elastomer preferably includes a polymer of styrene and its analogs and homologs, including alpha-methylstyrene, and ring-substituted styrenes, particularly ring-methylated styrenes, or a combination thereof. The preferred styrenics are styrene and alpha-methylstyrene, with styrene being especially preferred. The styrene content of the styrene-based elastomer typically ranges from about 4 weight percent to 90 weight percent, preferably from about 6 weight percent to 75 weight percent, and more preferably from about 9 weight percent to 70 weight percent. The hydrogenated olefinic component of the styrene-based elastomer may include ethylene, butylene, propylene, or a combination thereof. One or more hydrogenated styrene butadiene random copolymers may be used in place of, or in addition to, any styrene-based elastomer.

The hydrogenation of the styrene-based elastomer is preferably selective, such that at least about 80% of the double bonds in the olefinic component are hydrogenated while less than about 65% of the double bonds of the styrenic portion are hydrogenated, and preferably no more than about 25% of the double bonds of the styrenic portion are hydrogenated. In one embodiment, at least about 90% of the double bonds in the olefinic component of the styrene-based elastomer are hydrogenated. One suitable method for the selective hydrogenation of styrene-based elastomers is disclosed in, for example, U.S. Pat. No. 3,595,942, which is incorporated herein by express reference thereto.

In one embodiment, the triblock form of the styrene-based elastomer preferably includes styrene-ethylene-butylene-styrene, styrene-ethylene-propylene-styrene, styrene-ethylene-propylene-styrene-styrene-ethylene-propylene-styrene, or styrene-ethylene-ethylene-propylene-styrene, or any combination thereof. In another embodiment, the hydrogenated olefinic component includes hydrogenated butadiene and crystalline polyethylene is used in place of at least one of the styrene block components.

The styrene-based elastomer component may be grafted or ungrafted. In one embodiment, the styrene-based elastomer is essentially free of grafted functional groups (e.g., unsaturated dicarboxylic acid or anhydrides). In another embodiment, the styrene-based elastomer is completely free of grafted functional groups. In a preferred embodiment, the thermoplastic polyolefin blend of the present invention is essentially free of unsaturated dicarboxylic acids and unsaturated dicarboxylic anhydrides.

The styrene-based elastomer component has a typical melt flow rate (as determined by ASTM D-1238-01 at a temperature of 230° C. and at a load of 2.16 kg) from about 0.001 dg/min to 200 dg/min, preferably from about 0.005 dg/min to 185 dg/min, and more preferably from about 0.01 dg/min to 155 dg/min. The styrene-based elastomer component is further characterized by a density typically ranging from about 0.790 g/cm³ to about 1.05 g/cm³, preferably from about 0.80 g/cm³ to 1.01 g/cm³, and more preferably from about 0.85 g/cm³ to 0.99 g/cm³. In various embodiments, the density of the styrene-based elastomer component as a whole is from about 0.87 g/cm³ to about 0.93 g/cm³, or from about 0.92 g/cm³ to 0.97 g/cm³.

Exemplary styrene-based elastomers suitable for inclusion in the styrene-based elastomer component are commercially available as TUFTEC from Asahi America Inc. of Malden, Mass., as SEPTON from Kuraray Company, Ltd. Of Tokyo, Japan, as KRATON from Kraton Polymers of Houston, Tex., as DYNAFLEX from GLS Corporation of McHenry, Ill., or as DYNARON from Japan Synthetic Resin of Tokyo, Japan.

The processability modifier component is defined as a compound that contains at least one pair of oxygen atoms bonded by a single covalent bond. The amount of active oxygen present in the overall thermoplastic polyolefin blend typically ranges from about 4 parts per million to 500 parts per million (ppm), preferably from about 10 ppm to 250 ppm, and more preferably from about 15 ppm to 165 ppm. Typically, the processability modifier component may include one or more organic peroxides, organic hydroperoxides, organic azo compounds, or inorganic peroxides, percarbonates, and perborates compounds, or any combination thereof. The processability modifier component may be or may include a pure liquid, or a dry solid, such as liquid peroxide absorbed onto an inert carrier, such as polypropylene or silica, or in a blend with mineral oil, or even as a combination of a pure liquid and a solid.

Processability modifiers useful for inclusion in the processability modifier component of this invention preferably include one or more organic peroxides and should have a decomposition half-life of greater than about one hour at 100° C. Half-life is defined as the time required to reduce the original peroxide concentration by half. Representative peroxides that are particularly useful include peroxyketals, such as 1,1-bis(t-butylperoxy)-3,3,5-trimethylcyclohexane; hydroperoxides, such as cumene hydroperoxide; dialkyl peroxides, such as di-t-butyl peroxide, dicumyl peroxide, t-butylcumyl peroxide, 2,5-dimethyl-2,5-bis(t-butylperoxy)hexane, etc.; diacyl peroxides, such as acetyl peroxide; peroxyesters, such as t-butyl peroxyacetate; or any combination thereof. Among these compounds, preferably at least one dialkyl peroxide with a half-life of greater than one hour at 100° C. is preferable.

It is known that free radical reactions using organic peroxide are typically used in the preparation of the vinyl cyanide component of the present invention. Such a process is disclosed in, e.g., U.S. Pat. No. 3,893,968 and is expressly incorporated herein by reference thereto. Any residual free radicals are typically deactivated and any unreacted organic peroxide is typically decomposed, however, during the copolymerization process, leaving no free active oxygen available to serve as a processability modifier component according to the present invention. Thus, a separate processability modifier component is added according to the invention.

A variety of conventional additives may also be optionally, but preferably, included in the compositions of the invention, including one or more thermal stabilizers, mineral fillers, ultraviolet stabilizers, antioxidants, flame retardants, dispersants, antistatic agents, internal lubricants, processing aids, nucleating agents, plasticizers, colorants, mold release agents, pigments, and the like, or combinations thereof.

Suitable internal lubricants include, but are not limited to, fatty acids (e.g., stearic acid, 12-hydroxystearic acid, and the like), fatty acid esters (e.g., glycerol monooleate, pentaerythritol tetrastearate, butyl stearate, and the like), fatty acid amides (e.g., oleic acid amide, erucamide, bis(stearoyl) ethylenediamine, and the like), polyolefin waxes (e.g., polypropylene waxes, polyethylene waxes, and the like), and silicone oil (e.g., polyorganosiloxanes, polydimethylsiloxanes having a viscosity from about 13,000 to 100,000 centistokes, ultrahigh molecular weight functionalized siloxane polymers, siloxanes with linear alkyl side chains, and the like), and any combination thereof. In a preferred embodiment, the processing aid is a combination of at least one silicone oil and at least one fatty acid amide. When such optional processing aids are included, they may typically be present in an amount of about 0.01 weight percent to 10 weight percent, preferably in an amount of about 0.1 weight percent to 9 weight percent, and more preferably in an amount of about 0.4 weight percent to 7 weight percent, based on the total weight of the polymers present in the blend.

Suitable pigments include, but are not limited to, inorganic pigments and colorants (e.g., metal oxides and chromates, and the like), organic pigments, and the so-called special effects pigments (e.g., metallic flake and pearlescent pigments, and the like), or a combination thereof. The pigment is preferably first dispersed in a suitable carrier, such as low molecular weight polyolefin material, before being introduced into the present inventive blend. When such optional pigments are included, they may typically be present in an amount of about 0.01 weight percent to 13 weight percent, preferably in an amount of about 0.1 weight percent to 10 weight percent and more preferably in an amount of about 0.5 weight percent to 9 weight percent, based on the total weight of the polymers present in the blend.

Suitable mineral fillers include, but are not limited to, talc, ground calcium carbonate, precipitated calcium carbonate, precipitated silica, precipitated silicates, precipitated calcium silicates, pyrogenic silica, hydrated aluminum silicate, calcined aluminosilicate, clays, mica, wollastonite, and any combination thereof. When one or more such optional mineral fillers are included, they may typically be present in an amount of about 1 weight percent to 40 weight percent, preferably in an amount of about 2 weight percent to 20 weight percent in one embodiment and in an amount of about 15 weight percent to 35 weight percent in another embodiment, based on the total weight of the polymers present in the blend.

Melt blending is one suitable method for preparing the thermoplastic polyolefin blend of the present invention from the various components, additives, and fillers described herein, although any suitable polymer blending techniques available to those of ordinary skill in the art may be used. Techniques for melt blending of a polymer with additives of all types are known to those of ordinary skill the art and can typically be used with the present invention. In one type of melt blending operation useful with the present invention, the individual components of the blend are combined in a mechanical extruder or mixer, and then heated to a temperature sufficient to form a polymer melt. In a preferred embodiment, the semi-crystalline polypropylene resin component, the styrene-based elastomer component and the vinyl cyanide component are melt blended together in the presence of a processability modifier component at a temperature of about 120° to 300° C., preferably about 140° to 280° C., and more preferably about 200° to 275° C.

The mechanical mixer can be a continuous or batch mixer. Examples of suitable continuous mixers include single screw extruders, intermeshing co-rotating twin screw extruders such as Werner & Pfleiderer ZSK™ extruders, and reciprocating single screw kneaders such as Buss™ co-kneaders. Examples of suitable batch mixers are lateral 2-roll mixers such as Banbury™ or Boling™ mixers. The temperature of the melt, residence time of the melt within the mixer, and the mechanical design of the mixer are several well-known variables that control the amount of shear to be applied to the composition during mixing, and can be readily selected by one of ordinary skill in the art based on the disclosure of the invention herein.

The thermoplastic polyolefin blend of the current invention may be pelletized, e.g., via strand pelletizing or commercial underwater pelletization. Pellets of the present composition may then be easily processed into shaped articles by any available method(s) in the art, including injection molding, profile extrusion, blow molding, and other forming processes, to give products having well-balanced properties in scratch resistance, stiffness and mar abrasion resistance, and preferably also having a glossy surface.

In one embodiment, the mar abrasion resistant thermoplastic polyolefin blend of the present invention is co-extruded as one layer adjacent one or more additional layers or sheets formed of a conventional thermoplastic polyolefin blend. Preferably, the mar abrasion resistant TPO blend of the invention is disposed over any other layers and forms the top or outermost layer of the article. An optional backing layer may be added. The resulting composite material does not require the formation of separate sheets or the separate bonding of sheets as is commonly used in lamination. Due to the compatibility of the mar abrasion resistant thermoplastic polyolefin layer and the conventional thermoplastic polyolefin layer, no additional tie layer is required and the mar abrasion resistant thermoplastic polyolefin layer of the invention may be directly extruded over a layer formed from the conventional thermoplastic polyolefin blend. If desired, the co-extrusion method disclosed in U.S. Patent Application No. 2002/055006 is suitable and is expressly incorporated herein by reference thereto. Other co-extrusion techniques can be used, such as multiple extrusion heads, or with a multiple manifold flow divider and a single die head. Typical automotive industry applications for articles including the inventive TPO blend include instrument panels, interior trim components, bumpers, fascias, exterior trim, and the like. In addition, signage, device housings, sinks, body panels and engine shrouds for all-terrain vehicles, tractors and combines, household appliance cabinets and door liners, and other articles requiring good surface appearance, scratch resistance and mar abrasion resistance can be made from the inventive materials.

In order to measure surface scratch resistance, the Ford Laboratory Test Method BN 108-13 “Resistance to Scratching” was modified for the requirements of the present invention. The apparatus uses a pneumatically driven sledge with five metal fingers (250 mm long). One end of each metal finger was fixed while the other end was supplied with an interchangeable scratch pin with a stainless steel tip (1.0 mm in diameter). The pins were loaded with different weights to exert standard forces on the surface of the test material. The loads were increased, as allowed in the Ford Laboratory Test Method, in order to meet the required scratch forces on the surface of the samples such that the loading forces, reported in Newtons (N), were 2, 5, 10, 15, and 20 N.

The test specimens were 100 mm×200 mm plaques conditioned at room temperature for more than 40 hours prior to testing. The test plaques were clamped under the five metal fingers of the apparatus, which were then pneumatically drawn across the surface of the plaque at a constant velocity of approximately 100 mm per second. All tests were performed once for each plaque at room temperature. Upon completion of the test, the specimens were then evaluated visually on a numerical scale of 1 to 5 where:

| Scratch Rating | Description |
|---|---|
| 1 | No visible scratch |
| 1.5 | Gloss change without deformation |
| 2 | Slight deformation |
| 2.5 | Moderate deformation |
| 3 | Slight ribbing in scratch |
| 3.5 | Frequent ribbing |
| 4 | Continuous ribbing |
| 4.5 | Points of tearing |
| 5 | Continuous tearing |

Gloss is defined as angular selectivity of reflectance, involving surface-reflected light, responsible for the degree to which reflected highlights or images of objects may be see as superimposed on a surface (ASTM E 284-03a). Gloss is a complex attribute of a surface that cannot be completely measured by any single number (ASTM D 2457-03). Mar abrasion resistance is defined as the ability of a material to resist appearance degradation caused by small-scale mechanical stresses under a specific set of conditions. Haze is defined as a cloudy appearance attributable to light scattering. Although mar abrasion may be masked or hidden by a hazy surface appearance, such a hazy condition is clearly noticeable and is undesirable for a shaped or molded part with a glossy surface.

The mar abrasion test is used to determine the ability of a surface to resist damage caused from light abrasion by simulating the effects of a car-washing installation on a glossy, unpainted surface. To counteract the coating effect of the surfactant, a dry, as opposed to a wet, abrasion method is used. The distinguishing features of the mar abrasion test are the mildness of the damaging conditions and the focus on accessing the appearance of the damaged surface. Damage caused by conventional mar tests, such as the crockmeter and the Taber abraser, is too severe to accurately assess mar abrasion. The test method does not provide fundamental values for mar abrasion resistance, but it is suitable for estimating the ability of a high gloss, or glossy, surface to resist mar.

The test specimens were 100 mm×200 mm plaques conditioned at room temperature for more than 40 hours prior to testing. One single-ply, low-linting, slightly abrasive wiper cloth was folded into a square with dimensions of 5.5×5.5 cm. The plaque was then placed on a horizontal, solid surface, such as a tabletop, and the wiper cloth was dragged over the surface of the plaque using a constant force in a clock-wise, circular motion for five seconds. A new square of wiper cloth is required for each determination of mar abrasion resistance. Upon completion of the test, the specimens were evaluated visually using the following ratings scale:

| Mar abrasion rating | Appearance |
|---|---|
| ⊚ | No visible change to the surface of the |
| | plaque |
| ◯ | Marks appear as short, thin lines spaced |
| | about 1 mm apart |
| Δ | Marks appear as continuous lines spaced |
| | closely together (i.e., <1 mm apart) |
| X | Individual lines cannot be distinguished; |
| | test area on surface of plaque is dull |

The term “about,” as used herein, should generally be understood to refer to both numbers in a range of numerals. Moreover, all numerical ranges herein should be understood to include each whole integer within the range.

“Essentially free,” as used herein, refers to no more than about 5 percent, preferably no more than about 1 percent, and more preferably no more than about 0.5 percent of the characteristic referred to. In one preferred embodiment, “essentially free” refers to less than 0.1 percent. “Completely free,” as used herein, refers to less than 0.01 percent of the characteristic referred to or preferably the complete absence of the characteristic.

The term “substantially free,” as used herein in reference to defects, should be understood to mean that the outer surface of an article prepared with a blend of the invention has less than about 10 percent, preferably less than about 5 percent, and more preferably less than about 1 percent, of its surface area covered with visible defects. The term also includes the preferred embodiment, in which articles of the invention contain no visible surface defects. Most preferably, the outer surface of an article prepared with the present blend should be “entirely free” of defects, (i.e., there are no surface defects, whether visible or not).

All of the patents and other publications recited in this Detailed Description are incorporated herein by express reference thereto.

### EXAMPLES

The invention is further defined by reference to the following examples, describing the preparation of some exemplary thermoplastic polyolefin blends of the present invention. It will be apparent to those of ordinary skill in the art that many modifications, both to materials and methods, may be practiced without departing from the purpose and intent of this invention based on the description herein. Thus, the following examples are offered by way of illustration, and not by way of limitation, to describe in greater detail certain methods for the preparation, treatment, and testing of some thermoplastic blends of the invention.

The significance of the symbols used in these examples, the units expressing the variables mentioned, and the methods of measuring these variables, are explained below.

| | |
|---|---|
| MFR [dg/min] | Melt Flow Rate, reported as dg/min at 230° C., |
| | under a load of 2.16 kg, according to |
| | ASTM D-1238-01 |
| Flex Modulus [MPa] | Flexural Modulus, reported as mega-Pascals at |
| | 23° C. with a test speed of 2 mm/min and a test |
| | specimen of dimensions 4 × 10 × 80 mm, |
| | according to ISO 178 (2001) |
| Tensile Strength | Tensile Strength, reported as mega-Pascals at |
| [MPa] | 23° C. with a test speed of 50 mm/min on |
| | Type 1A bars with dimensions of 150 × 10 × |
| | 4 mm, according to ISO 527-2 (1993) |
| Tensile Modulus | Modulus of elasticity in tension, reported as |
| [MPa] | mega-Pascals at 23° C. with a test speed of |
| | 50 mm/min on Type 1A bars with dimensions of |
| | 150 × 10 × 4 mm, according to ISO 527-2 (1993) |
| Surface appearance | Visual observation of the molded sample before |
| | testing; yes = good; no = poor (cloudy) |
| Gloss at 60° | Specular gloss, measured with gloss meter at 60° |
| | angle of incidence on a 4″ × 8″ × 3 mm test |
| | specimen, according to ASTM D2457-03 |
| Scratch on Surface | As described in text, reported at 20N |
| Mar abrasion | As described in text |

Materials used in the examples:

| | |
|---|---|
| PP-1 | Polypropylene homopolymer; Density: 0.905 g/cm³; |
| | MI: 8 dg/min at 230° C. and 2.16 kg weight |
| PP-2 | Propylene block copolymer; Density: 0.905 g/cm³; |
| | MI: 65 dg/min at 230° C. and 2.16 kg weight |
| SBC-1 | Styrene-based elastomer; Styrene content 67%; Specific |
| | Gravity: 0.97; MI: 2.0 dg/min at 230° C. and 2.16 kg |
| | weight |
| SBC-2 | Styrene-based elastomer; Styrene content 12%; Specific |
| | Gravity: 0.89; MI: 4.5 dg/min at 230° C. and 2.16 kg |
| | weight |
| AEPS | Poly(acrylonitrile ethylene-propylene styrene) copolymer; |
| | Density: 1.05 g/cm³; MI: 6 dg/min at 230° C. and 10 kg |
| | weight |
| Processability | 2,5-Dimethyl-2,5-di(t-butyl peroxy) hexane |
| Modifier | |
| Additives | Internal lubricants, antioxidant, color concentrate |

### Example 1

### A Thermoplastic Polyolefin Blend According to the Invention

A blend was prepared by adding 33 ppm of the processability modifier to 100 parts by weight of a mixture containing 69 weight percent of polypropylene (PP-1), 16 weight percent of vinyl cyanide component (AEPS), and 10 weight percent of styrene-based elastomer (SBC-1). The remaining 5 weight percent of additives included silicone oil, antioxidants, and color concentrate. This blend was prepared in a Leistritz 27 mm co-rotating twin screw laboratory extruder Model TSE-27 with a length to diameter ratio (L/D) of 52. The extrusion temperature was 200° to 245° C., and the extruder speed was 370 to 420 rpm.

Test specimens in the form of bars were prepared by injection molding using a Van Dorn 120HT Injection Molding Machine at a melt temperature of 240° C. and a mold cavity temperature of 74° C. Test specimens in the form of plaques were molded using a HPM Command 90 Molding Machine at a melt temperature of 240° C. and a mold cavity temperature of 74° C. Results are shown in Table 1. Example 1 shows the surprising and unexpected results of a good surface appearance with no haze or cloudiness and a good mar abrasion resistance obtained with the inclusion of a processability modifier component and a vinyl cyanide component of the invention.

### Comparative Example 1

### A Blend with a Conventional Styrene-Based Elastomer

A blend was prepared in the same manner as that in Example 1, except for changing the polypropylene to PP-2 and also the styrene-based elastomer to SBC-2. No processability modifier component or vinyl cyanide component was added to the blend. Test specimens were molded at a melt temperature of 35° in the same manner as Example 1, and results are shown in Table 1. Comparative Example 1 illustrates that a simple blend of 71 weight percent semi-crystalline polypropylene resin, 24 weight percent styrene-based elastomer, and 5 weight percent additives showed fairly good scratch resistance, but could not resist mar abrasion.

### Comparative Example 2

### A Blend with no Processability Modifier Component

A blend was prepared in the same manner as that in Example 1, except that no processability modifier component was added to the mixture of 69 weight percent PP-1, 16 weight percent AEPS, 10 weight percent SBC-1, and 5 weight percent additives. Test specimens were prepared in the same manner as Example 1, and results are shown in Table 1. Comparative Example 2 illustrates the unacceptably hazy surface appearance of a blend that did not contain the processability modifier component of the invention.

### Comparative Example 3

### A Blend with no Styrene-Based Elastomer Component

A blend was prepared in the same manner as that in Example 1, except that no styrene-based elastomer component was added to the mixture of 69 weight percent PP-1, 26 weight percent AEPS, 5 weight percent additives, and 33 ppm of processability modifier. Test specimens were prepared in the same manner as Example 1, but no further tests were run on the test specimens in view of the lack of blend formation. Comparative Example 3 illustrates that, without the presence of the styrene-based elastomer, a blend containing the semi-crystalline polypropylene resin component and the vinyl cyanide component, even with the processability modifier, does not engender a sufficient number of chain entanglements to become miscible. Instead, this material formed two distinct phases instead of a blend. In addition, the processability modifier did not serve as a compatibilizer in the amounts used in the present invention.

### Comparative Example 4

### A Blend Lacking Vinyl Cyanide Component

A blend was prepared in the same manner as that in Example 1, except that no vinyl cyanide component was added to the mixture of 69 weight percent PP-1, 26 weight percent SBC-1, 5 weight percent additives, and 33 ppm processability modifier. Test specimens were prepared in the same manner as Example 1, and results are shown in Table 1. Comparative Example 4 illustrates that the vinyl cyanide component should be present to ensure good mar abrasion resistance.

TABLE 1

| | | Comp. | Comp. | Comp. | Comp. |
|---|---|---|---|---|---|
| | Ex. 1 | Ex. 1 | Ex. 2 | Ex. 3 | Ex. 4 |
| MFR [dg/min] | 20 | 32 | 7 | NA | 20 |
| Flex Modulus [MPa] | 1628 | 765 | 1674 | NA | 1748 |
| Tensile Strength [MPa] | 28 | 22 | 31 | NA | 32 |
| Tensile Modulus [MPa] | 2011 | 854 | 2028 | NA | 1987 |
| Surface appearance | Good | Good | Hazy | NA | NA |
| Gloss at 60° | 85.3 | 85 | 83.2 | NA | NA |
| Scratch on surface @ | 2.5 | 3.0 | 2.5 | NA | 3.5 |
| 20N | | | | | |
| Mar abrasion test | ◯ | X | ◯ | NA | X |

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A thermoplastic polyolefin blend comprising:
a semi-crystalline polypropylene resin component in an amount sufficient to impart rigidity to the blend;
a vinyl cyanide component in an amount sufficient to impart mar abrasion resistance to the blend;
a styrene-based elastomer component in an amount sufficient to compatibilize the blend; and
a processability modifier component containing at least one pair of oxygen atoms bonded by a single covalent bond in an amount sufficient to enhance processability of the blend.

2. The blend of claim 1, wherein the processability modifier is present in an amount sufficient to impart an active oxygen content of about 4 ppm to 500 ppm of the thermoplastic blend.

3. The blend of claim 2, wherein the amount of active oxygen present is from about 10 ppm to 250 ppm of the thermoplastic blend.

4. The blend of claim 1, wherein the semi-crystalline polypropylene resin component is present in an amount from about 1 weight percent to 99 weight percent, the vinyl cyanide component is present in an amount from about 1 weight percent to 75 weight percent, and the styrene-based elastomer component is present in an amount from about 0.01 weight percent to 75 weight percent, each based on the total weight of the polymers in the blend.

5. The blend of claim 1, wherein the semi-crystalline polypropylene resin component is present in an amount from about 20 weight percent to 95 weight percent, the vinyl cyanide component is present in an amount from about 5 weight percent to 60 weight percent, and the styrene-based elastomer component is present in an amount from about 0.1 weight percent to 70 weight percent, each based on the total weight of the polymers in the blend.

6. The blend of claim 1, wherein the processability modifier component comprises one or more organic peroxide components, organic hydroperoxide components, organic azo components, inorganic peroxides, percarbonate and/or perborate components, or any combination thereof.

7. The blend of claim 6, wherein the organic peroxide is present and comprises one or more peroxyketals; hydroperoxides; dialkyl peroxides; diacyl peroxides; peroxyesters; or any combination thereof.

8. The blend of claim 1, wherein the vinyl cyanide component is in the form of a rubber-reinforced copolymer resin comprising at least one polar vinyl monomer present in an amount from about 5 weight percent to 75 weight percent, at least one aromatic vinyl monomer in an amount from about 10 weight percent to 80 weight percent, and at least one rubber moiety present in an amount from about 15 weight percent to 85 weight percent, each based on the total weight of the vinyl cyanide component.

9. The blend of claim 8, wherein the at least one polar vinyl monomer is present in an amount from about 10 to 65 weight percent, the at least one aromatic vinyl monomer is present in an amount from about 10 to 65 weight percent, and the at least one rubber moiety is present in an amount from about 25 to 60 weight percent, each based on the total weight of the vinyl cyanide component.

10. The blend of claim 8, wherein the at least one polar vinyl monomer comprises one or more of acrylonitrile, acrylic acid esters, methacrylic acid esters, or a combination thereof; the at least one aromatic vinyl monomer comprises styrene, p-methylstyrene, o-methylstyrene, ethylstyrene, 2,4-dimethylstyrene, and vinylnaphthalene, or a combination thereof; and the at least one rubber moiety comprises ethylene/propylene rubber, ethylene/propylene/diene rubber, or a combination thereof.

11. The blend of claim 1, wherein the vinyl cyanide component comprises one or more of ethylene/propylene rubber-reinforced styrene/acrylonitrile copolymers, ethylene/propylene/diene rubber-reinforced styrene/acrylonitrile copolymers, ethylene/propylene rubber-reinforced acrylate/styrene/acrylonitrile copolymers, and ethylene/propylene/diene rubber-reinforced acrylate/styrene/acrylonitrile copolymers.

12. The blend of claim 1, wherein the styrene-based elastomer component is in the form of a block or random styrene copolymer that includes a styrenic component and a hydrogenated olefinic component.

13. The blend of claim 12, wherein the styrene-based elastomer component is selectively hydrogenated so that at least about 80% of the double bonds in the hydrogenated olefinic component are hydrogenated and less than about 65% of the double bonds of the styrenic component are hydrogenated.

14. The blend of claim 12, wherein the styrene-based elastomer component comprises styrene-ethylene-butylene-styrene, styrene-ethylene-propylene-styrene, styrene-ethylene-propylene-styrene-styrene-ethylelene-propylene-styrene, or styrene-ethylene-ethylene-propylene-styrene, or a combination thereof.

15. The blend of claim 1, wherein the semi-crystalline polypropylene resin component comprises one or more homopolymers of propylene, one or more copolymers of at least 50 weight percent propylene and at least one other C₂ to C₂₀ alpha-olefin, or mixtures thereof, and the resin component is present in an amount of about 30 weight percent to 90 weight percent based on the total weight of the polymers in the blend.

16. The blend of claim 1, further comprising one or more thermal stabilizers, mineral fillers, ultraviolet stabilizers, antioxidants, flame retardants, dispersants, antistatic agents, internal lubricants, processing aids, nucleating agents, plasticizers, colorants, mold release agents, pigments, or a combination thereof.

17. The blend of claim 16, wherein an internal lubricant is present and comprises one or more fatty acids, fatty acid esters, fatty acid amides, polyolefin waxes, silicone oil, or a combination thereof.

18. A molded article comprising the blend of claim 1.

19. An extruded article comprising the blend of claim 1.

20. A co-extruded article, wherein the blend of claim 1 is extruded as the top layer directly over a layer formed of a second, different thermoplastic polyolefin blend.

21. A method of preparing a thermoplastic polyolefin blend which comprises:
providing a semi-crystalline polypropylene resin component in an amount sufficient to impart rigidity to the blend, a vinyl cyanide component in an amount sufficient to impart mar abrasion resistance to the blend, a styrene-based elastomer component in an amount sufficient to compatibilize the blend, and a processability modifier component containing at least one pair of oxygen atoms bonded by a single covalent bond, to form a polymerizable blend; and
copolymerizing the polymerizable blend sufficiently to provide the thermoplastic polyolefin blend.
